(19) United States
(12) Patent Application Publication
(10) Pub. No.: US 2024/0265605 A1
(43) Pub. Date: Aug. 8, 2024

(54) GENERATING AN AVATAR EXPRESSION

(71) Applicant: GOOGLE LLC, Mountain View, CA (US)

(72) Inventors: Ruofei Du, San Francisco, CA (US); Xingyu Liu, Los Angeles, CA (US)

(21) Appl. No.: 18/165,779

(22) Filed: Feb. 7, 2023

(51) Int. Cl. G06T 13/20; G06T 13/40; G06T 13/80; G10L 25/63

(52) U.S. Cl. CPC G06T 13/205; G06T 13/40; G06T 13/80; G10L 25/63

(57) ABSTRACT

A system and method may receive audio signal information associated with a user. An expression prediction may be determined by executing an expression determination model using the audio signal information as input. An avatar animation may be generated based on the expression prediction, where the avatar animation includes non-verbal expression representing the expression prediction.

### TECHNICAL FIELD

This disclosure describes systems and techniques that generate an avatar expression based on verbal and non-verbal communication of a user.

### BACKGROUND

Current methods generate avatars to represent users in video conferences, virtual reality, mixed reality, and augmented reality applications. Presently avatars mirror a user's expressions and speech to mimic that user. For example, if a user raises a left hand, smiles, and says hello, the avatar may be animated to make the exact same set of actions.

### SUMMARY

The disclosure describes a way to determine a non-verbal expression for an avatar based on a user's verbal communication. The disclosure also describes a way to determine a verbal expression for an avatar based on a user's non-verbal communication. One or both of non-verbal and verbal expressions can be used to generate an avatar animation including the expression(s). The technique may provide an avatar with enhanced expression of a user's communication for better connection and understanding between users.

In some aspects, the techniques described herein relate to a method including: receiving audio signal information associated with a user; determining an expression prediction by executing an expression determination model using the audio signal information as input; and generating an avatar animation based on the expression prediction, the avatar animation including non-verbal expression representing the expression prediction.

In some aspects, the techniques described herein relate to a system including: an audio information module configured to receive audio signal information associated with a user; an expression determination module configured to determine an expression prediction by executing an expression determination model using the audio signal information as input; and an avatar animation module configured to generate an avatar animation based on the expression prediction, the avatar animation including non-verbal expression representing the expression prediction.

In some aspects, the techniques described herein relate to a computing device, including: at least one processor; and a non-transitory computer-readable medium storing executable instructions that, when executed by the at least one processor, cause the computing device to: receive audio signal information associated with a user; determine an expression prediction by executing an expression determination model using the audio signal information as input; and generate an avatar animation based on the expression prediction, the avatar animation including non-verbal expression representing the expression prediction.

### BRIEF DESCRIPTION OF THE DRAWINGS

FIG. 1A depicts a scene, according to an example.

FIG. 1B depicts a scene, according to an example.

FIG. 2A depicts a frontal view a head mounted device, according to an example.

FIG. 2B depicts a rear view of a head mounted device, according to an example.

FIG. 2C depicts a system to generate an avatar expression, according to an example.

FIG. 2D depicts a block diagram of a device, according to an example.

FIG. 3A depicts a flow diagram, according to an example.

FIG. 3B depicts a flowchart, according to an example.

FIG. 4 depicts a method, according to an example.

### DETAILED DESCRIPTION

The present disclosure describes systems and techniques to generate an avatar expression including verbal and/or non-verbal expression representing a user. The avatar expression is generated using information derived from any combination of: an audio signal capturing a user's verbal communication, a visual frame capturing a user's non-verbal communication, and/or a motion or positioning capturing a user's gesture as inputs to an expression determination module. For example, a user's tone of voice, pitch, volume, a text translation of speech, or a language may be used to generate a hand gesture or facial expression, which is used to animate an avatar representing the user. In a further example, a user's facial expression or body pose may be used to generate an avatar's speech.

The technical solutions described in this disclosure may generate richer, multimodal actions for avatars because the avatars are not merely puppets that mimic users but appear to act intelligently by expressing things beyond a user's own literal verbal and non-verbal expressions. For example, if a user makes wave hand gesture, the technical solutions can generate an avatar expression including a speech output, “hello” along with a wave hand gesture. In this way, the technical solutions can enhance a user's verbal and non-verbal communication by providing a natural and expressive avatar that generates an enhanced avatar expression from an user expression.

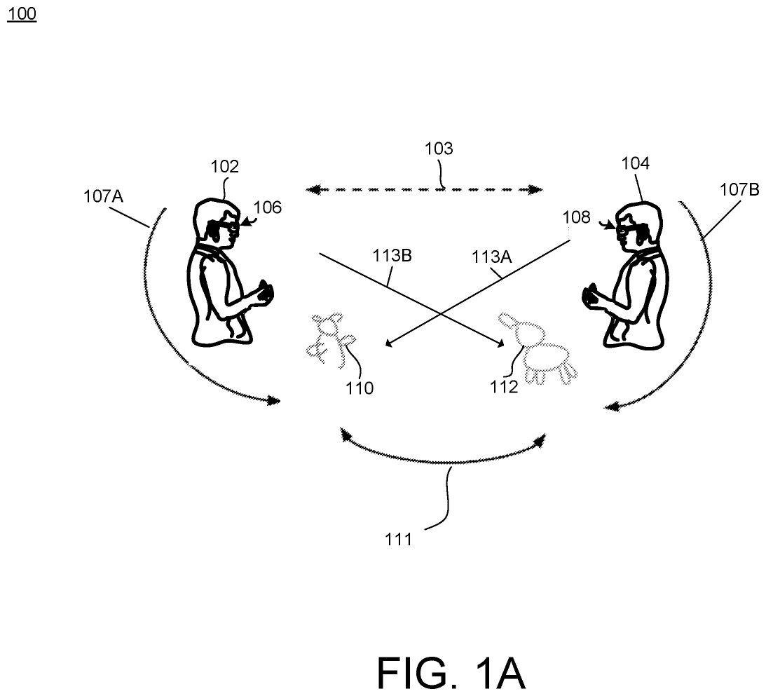

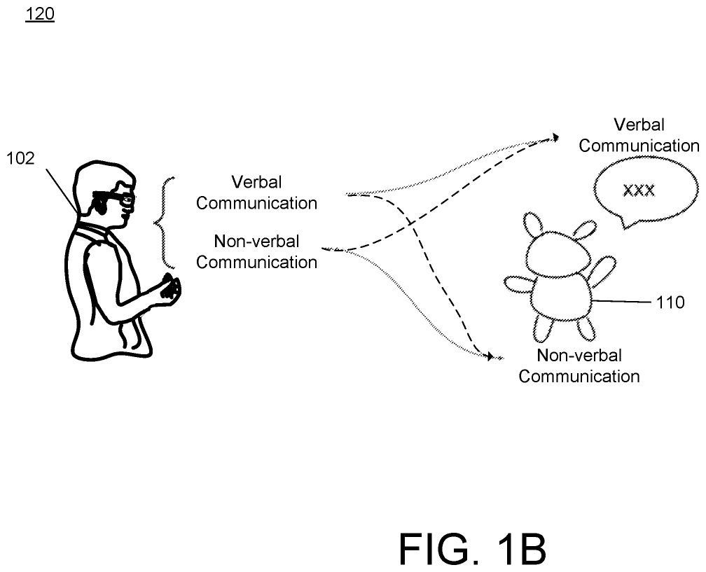

FIG. 1A depicts scene 100, in accordance with an example. Scene 100 includes a first user 102 and a second user 104 who are having an interaction 103 that includes verbal and/or non-verbal communication.

In examples, first user 102 may wear a first head mounted device 106, operable to display one or more avatars. In examples, head-mounted device 106 may be implemented as smart glasses (e.g., augmented reality, virtual reality, simulated reality, mixed reality, see-through reality, blended reality, or alternative reality glasses) configured to be worn on a head of a user. In examples, second user 104 may further wear a second head mounted device 108, which may be similar to first head mounted device 106.

Scene 100 is just one example that can illustrate the methods of the disclosure. In other examples, however, first user 102 and second user 104 may participate in a video conference via a screen display where first avatar 110 may appear alongside a video feed of first user 102 and second avatar 112 may appear alongside a video feed of second user 104. The video conference may include any number of users with any number of avatars. Other examples of users interacting with respective avatars that may utilize the methods of the disclosure are also contemplated.

Returning to scene 100, head-mounted devices 106 and 108 may be operable to display any combination of first avatar 110 associated with first user 102 and second avatar 112 associated with second user 104. In examples, only one of first user 102 or second user 104 may wear a head mounted device and view one or both of first avatar 110 and second avatar 112. In further examples, first user 102 may wear first head mounted device 106 and second user 104 may wear second head mounted device 108, each viewing one or both of first avatar 110 and second avatar 112.

First avatar 110 and second avatar 112 may comprise any likeness to first user 102 and second user 104, respectively. In examples, first avatar 110 and second avatar 112 may be human, animal, or any other imaginative character. In examples, first avatar 110 and second avatar 112 may make any range of gestures, speak, and/or make use of props. In examples, first avatar 110 and second avatar 112 may be 3-dimensional or 2-dimensional animations.

Under current methods, first avatar 110 and second avatar 112 may simply mimic first user 102 and second user 104, respectively. First user 102 and second user 104 may come from different cultural backgrounds or have very different communication styles, however. If first user 102 and second user 104 do not understand one another's communication styles, they may not understand one another any better based on avatars that merely mimic their actions. If first user 102 is used to a very muted communication style and second user 104 is used to a more animated communication style, for example, then second user 104 may misunderstand the degree of feelings felt by first user 102 on a matter. In other examples, first user 102 and second user 104 may not speak the same language at equal levels of fluency, and non-verbal clues may be needed to provide more context to their speech. In examples, one or both of first user 102 and second user 104 may have social-emotional agnosia or a similar challenge understanding facial expressions, body language, or voice intonation. As such, an avatar that simply mimics another user will not provide any additional help in the efforts of first user 102 and second user 104 to understand one another.

In examples, first avatar 110 and second avatar 112 may make gestures and speak in a manner intended to reflect or enhance what each of first user 102 and second user 104, respectively, are expressing verbally and/or non-verbally as is represented by arrow 107A and arrow 107B.

In examples, first avatar 110 and second avatar 112 may also make expressions that react to one another's expressions, as indicated by arrow 111. In examples, first avatar 110 may react to verbal and non-verbal expressions made by second user 104, as indicated by arrow 113A, and likewise second avatar 112 may react to verbal and non-verbal expressions made by first user 102, as indicated by arrow 113B.

While scene 100 depicts only 2 users, the technical solutions described in the disclosure may include additional users with additional associated avatars.

FIG. 1B depicts scene 120, according to an example. Scene 120 depicts first user 102 alongside first avatar 110. As may be seen in the figure, first user 102 communicates using verbal and non-verbal communication. Under current methods, verbal communication may be used to generate verbal expression in first avatar 110 and non-verbal communication may be used to generate non-verbal expression in first avatar 110, as represented by the solid lines in the figure. As such, first avatar 110 primarily mimics the communication of first user 102 under present methods. The methods of the disclosure provide first avatar 110 with enhanced communication, however. As indicated by the dotted lines in the figure, verbal communication from first user 102 may generate non-verbal expression in first avatar 110, and non-verbal communication from first user 102 may generate verbal expression in first avatar 110. In examples, any combination of these four input-output expression pathways is possible. In examples, first avatar 110 may also be animated with avatar expressions to react to second user 104 or second avatar 112.

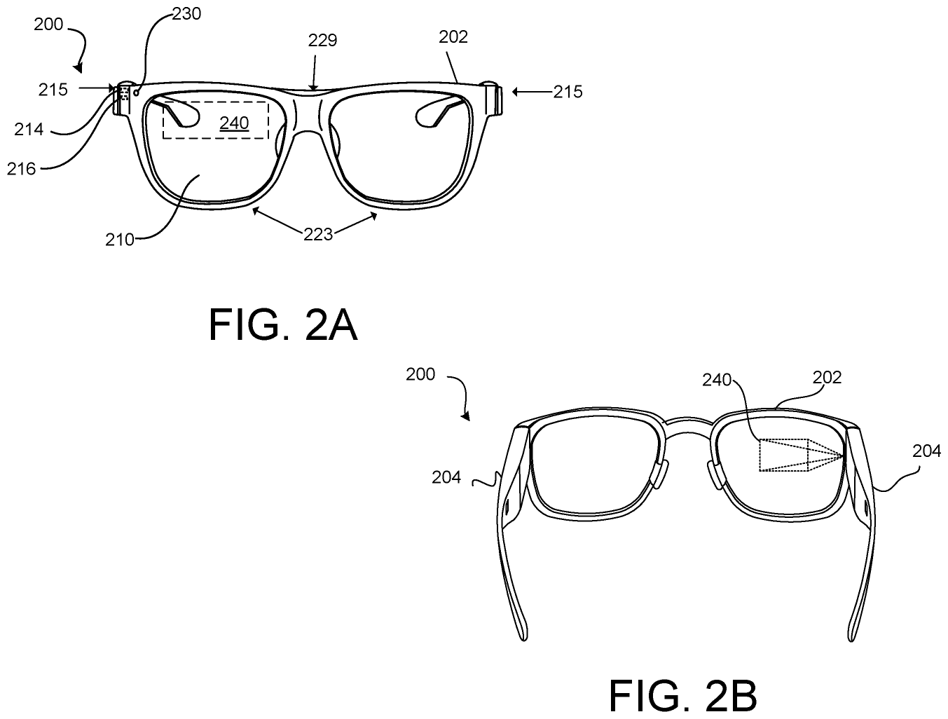

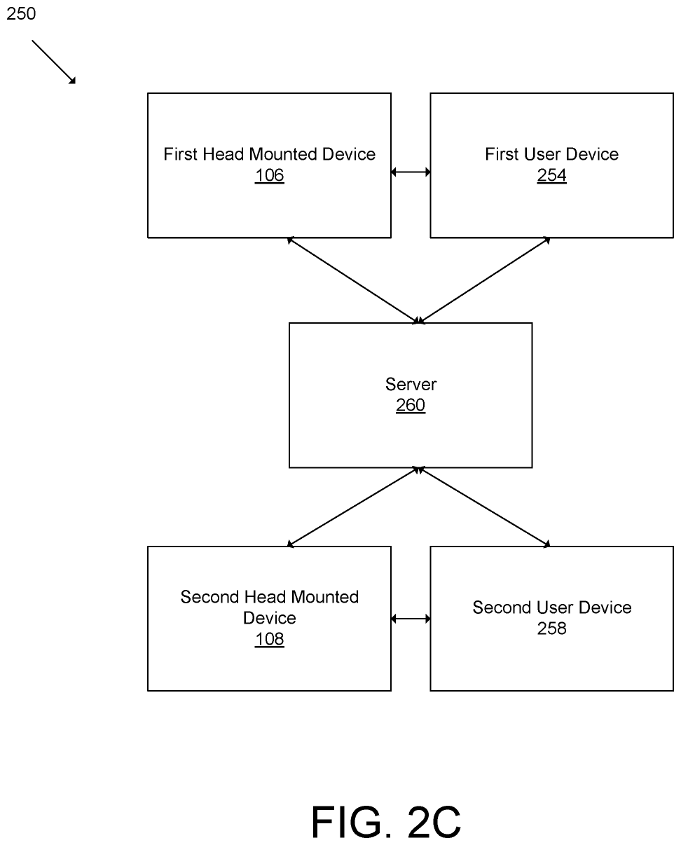

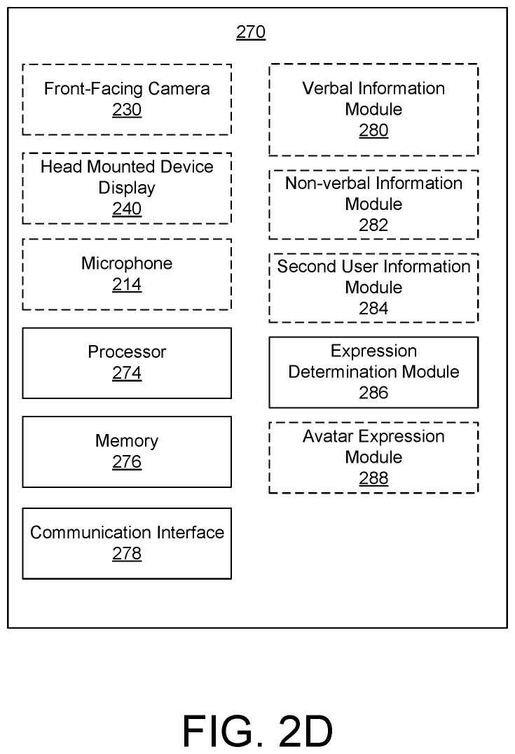

FIG. 2A depicts a frontal view and FIG. 2B depicts a rear view of a head mounted device 200, according to an example. Head mounted device 200, which may be an example of first head mounted device 106 or second head mounted device 108, is operable to display one or more avatars, such as first avatar 110 and/or second avatar 112. Head mounted device 200 may comprise smart glasses (e.g., augmented reality, virtual reality, simulated reality, mixed reality, see-through reality, blended reality, or alternative reality glasses) configured to be worn on a head of a user. In further examples, head mounted device 200 may be a virtual reality device. Head mounted device 200 may include display capability and computing/processing capability.

Head mounted device 200 includes a frameset with a front frame portion 202 and two arm portions 204, each respective arm portion being rotatably coupled to the front frame portion 202 by a hinge portions 215. In the example of FIGS. 2A and 2B, front frame portion 202 includes rim portions 223 surrounding respective optical portions in the form of lenses (including lens 210), the rim portions 223 being coupled together by a bridge portion 229 configured to rest on the nose of a user. The two arm portions 204 are coupled, for example, pivotably or rotatably coupled, to the front frame portion 202 at peripheral portions of the respective rim portions 223. In some examples, lenses 210 are corrective/prescription lenses. In some examples, the lenses 210 are an optical material including glass and/or plastic portions that do not necessarily incorporate corrective/prescription parameters.

In augmented reality examples, a user may view the world through the left lens and the right lens. In virtual reality applications, however, front frame portion 202 may include a display area that is opaque to the world beyond the headset. In virtual reality applications, two arm portions 204 may be part of a cover around the display connected to straps that keep the frameset in place on a user's head.

Head mounted device 200 includes a head mounted device display 240 configured to display content (e.g., an avatar, text, graphics, image, etc.) for one or both eyes. Head mounted device display 240 may cover all or part of front frame portion 202 of head mounted device 200. Head mounted device display 240 may include one or both of the left and right lens (of which lens 210 is one).

In examples, head mounted device 200 may include other sensing devices besides the eye tracking device. For example, the head mounted device 200 may include at least one front-facing camera 230. Front-facing camera 230 may be directed towards a front field-of-view or can include optics to route light from a front field of view to a sensor.

In examples, head mounted device 200 may further include at least one orientation sensor implemented as any combination of accelerometers, gyroscopes, and magnetometers combined to form an inertial measurement unit (IMU) to determine an orientation of a head mounted device.

In examples, head mounted device 200 may further comprise a microphone 214 and/or a speaker 216.

FIG. 2C depicts an example system 250 operable to perform the methods of the disclosure. The methods described in the disclosure may be executed on any device within system 250. System 250 may include any combination of first head mounted device 106, a first user device 254, second head mounted device 108, a second user device 258, and a server 260. In examples, first head mounted device 106 may be tethered (e.g., wired or wirelessly) to first user device 254 and/or second head mounted device 108 may be tethered (e.g., wired or wirelessly) to second user device 258. In examples, first head mounted device 106 and/or second head mounted device 108 may be communicatively coupled to server 260. In examples, first head mounted device 106 may be connected to server 260 via first user device 254 and second head mounted device 108 may be connected to server 260 via second user device 258. In examples, there may be further devices tethered (e.g., wired or wirelessly) to any of 106//, 254//, 108//, or 258//, such as smart watches, ear buds, cameras, and operable to send information from their respective sensors to the host device.

First user device 254 and second user device 258 may comprise any combination of mobile phones, handheld devices, laptop computers, or desktop computers.

The components of system 250 may communicate with one another via any wireless or wired method of communication. In examples, any combination of first head mounted device 106, first user device 254, second head mounted device 108 and second user device 258 may communicate over a local area network. Server 260 may be operable to communicate with first head mounted device 106, first user device 254, second head mounted device 108 and second user device 258 over the Internet.

FIG. 2D depicts a block diagram of device 270, according to an example. Device 270 is operable to receive verbal communication information and non-verbal information relating to a user and generate an expression prediction which may be used to animate an avatar based on that information. In examples, device 270 may be any of first head mounted device 106, first user device 254, second head mounted device 108, second user device 258, or server 260.

Device 270 includes a processor 274, a memory 276, a communication interface 278, and an expression determination module 286. In examples, 270 may further include any combination of front-facing camera 230, head mounted device display 240, microphone 214, a verbal information module 280, a non-verbal information module 282, a second user information module 284, and an avatar animation module 288. In examples, device 270 may include any of the additional electronics described with respect to head mounted device 200.

In examples, processor 274 may include multiple processors, and memory 276 may include multiple memories. Processor 274 may be in communication with any cameras, sensors, and other modules and electronics of device 270, or receiving signals from any of the devices of system 250. Processor 274 is configured by instructions (e.g., software, application, modules, etc.) to receive any combination of audio and non-verbal information and generate an avatar expression. The instructions may include non-transitory computer readable instructions stored in, and recalled from, memory 276. In examples, the instructions may be communicated to processor 274 from a another computing device, for example any device described in relation to system 250.

Communication interface 278 of device 270 may be operable to facilitate communication between any two of first head mounted device 106, first user device 254, and server 260. In examples, communication interface 278 may utilize Bluetooth, Wi-Fi, Zigbee, or any other wireless or wired communication methods.

In examples, processor 274 may be configured with instructions to execute verbal information module 280. Verbal information module 280 is operable to receive information relating to verbal communication by first user 102. In examples, verbal information module 280 may receive raw or processed audio signal data, or information derived from audio signal data.

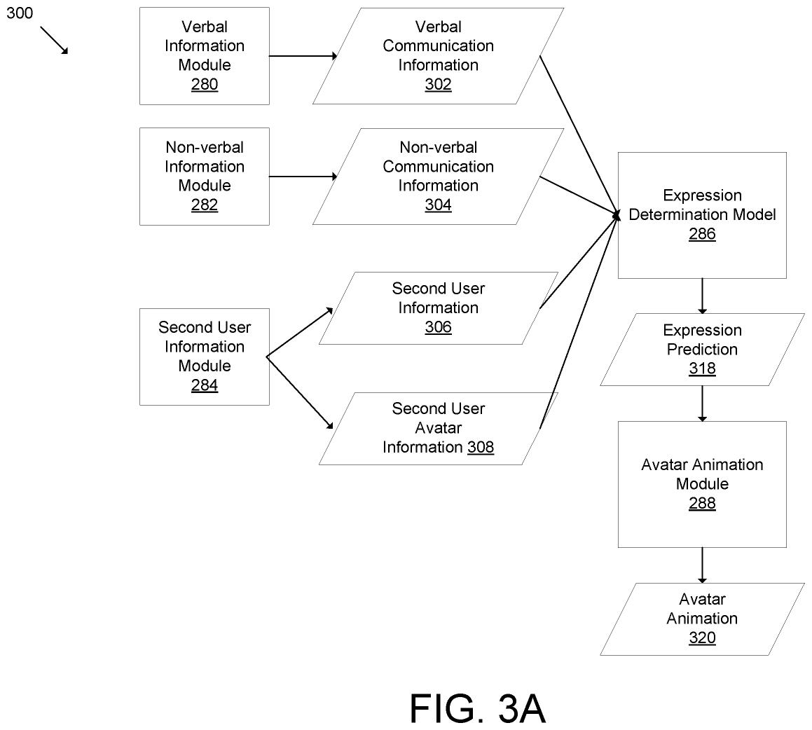

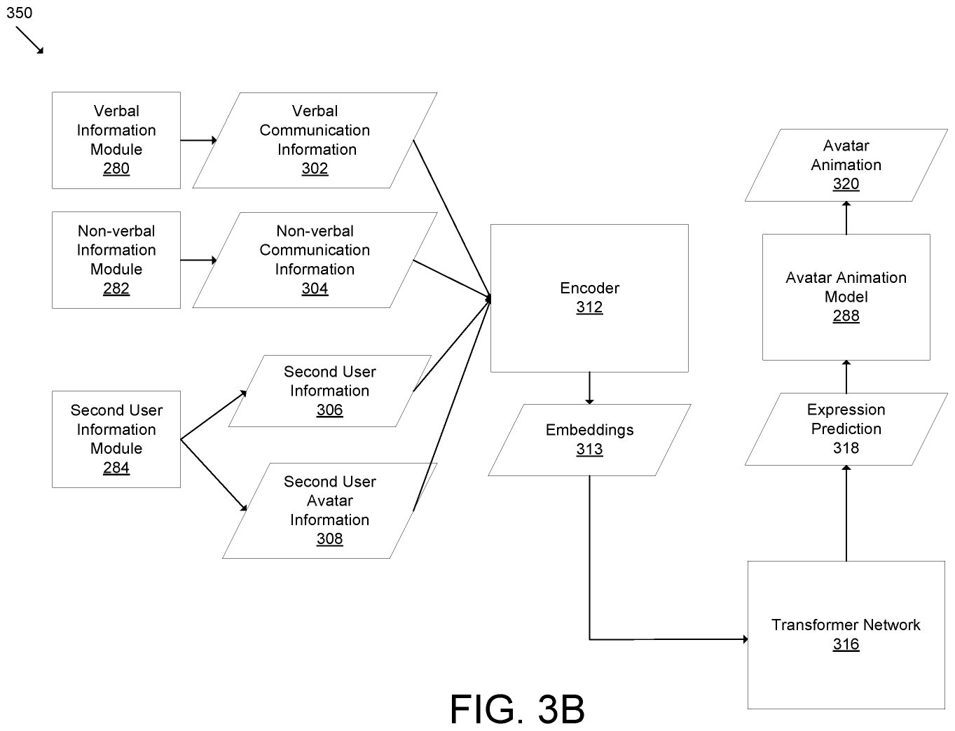

FIG. 3A depicts flow diagram 300, in accordance with an example. Flow diagram 300 begins with verbal information module 280 generating verbal communication information 302. Verbal communication information 302 may include information relating to verbal communication from a user.

In examples, the raw audio signal data may be recorded using a microphone. Microphone 214 may be internal or external to device 270. For example, verbal information module 280 may execute on first user device 254 and audio signal data may be received from microphone 214 embedded within first head mounted device 106. In examples, microphone 214 may be embedded in additional devices coupled to device 270, such as an ear bud device connected via Bluetooth.

In examples, verbal communication information 302 may include a raw or processed audio signal file, a speech spectrum, a text interpretation of user speech, a language spoken, or any information relating to a speech spectrum including pitch and volume information. In examples, verbal information module 280 may receive information from one or more machine models that use audio signal data as input to generate verbal communication information 302.

Returning to FIG. 2D, it may be seen that in examples processor 274 may be configured with instructions to execute non-verbal information module 282. Non-verbal information module 282 may be operable to receive a non-verbal information associated with the user correlating to the audio signal information. The non-verbal information may relate to non-verbal information communicated by first user 102. In examples, non-verbal information module 282 may capture motion information from other sensors as well.

Returning to flow diagram 300, it may be seen that non-verbal information module 282 generates non-verbal communication information 304. In examples, non-verbal communication information 304 may comprise information relating to facial expressions, body poses, body position landmarks, body motions, or any other physical expression that a user may make with their body or face or hands.

In examples, a camera used to generate one or more visual frames used to generate non-verbal communication information 304 may be external to device 270. In examples, the camera may be head mounted device display 240 on first head mounted device 106. In examples, the camera may be a camera used to generate a video feed for a video conference. In examples, the camera may be a front facing camera internal to second head mounted device 108, which is pointed at first user 102. In examples, a smart watch or a handheld device may be used to determine one or more body poses or hand gestures by tracking body motion with an inertial motion unit (IMU) embedded therein.

In examples, non-verbal information module 282 may receive raw data or processed data. For example, the one or more visual frames generated by a camera or IMU data generated by a smart watch tethered to device 270 may be used to generate non-verbal communication information 304.

In examples, non-verbal information module 282 may receive information generated by one or more machine models that use one or more visual frames or IMU data as input to generate non-verbal communication information 304.

In examples, processor 274 may be configured with instructions to execute second user information module 284. Second user information module 284 may be operable to receive or generate information about verbal/non-verbal communication from second user 104 and/or verbal/non-verbal expression from second avatar 112 based on audio, visual, or movement data.

Returning to FIG. 3A, it may be seen that second user information module 284 may generate one or both of second user information 306 and second user avatar information 308.

Second user information 306 may include any combination of the same features described with regards to verbal communication information 302 and non-verbal communication information 304, except it is generated with respect to second user 104 instead of first user 102.

Second user avatar information 308 may comprise any information describing one or more animations of second avatar 112. Second user avatar information 308 may be an expression prediction generated for second avatar 112, for example an expression prediction based on second user 104. In further examples, however, second user avatar information 308 may be determined based on a rendered avatar animation of second avatar 112.

Second user information module 284 may provide the information needed to allow first avatar 110 to respond to animations from second avatar 112 or communications made by second user 104. For example, second user information module 284 may determine that second avatar 112 is waving at first avatar 110, thereby allowing first avatar 110 may react.

In examples, processor 274 may be configured with instructions to execute expression determination module 286. Expression determination module 286 determines what expression a user is making through verbal and non-verbal communication so that that expression can be used to animate an avatar. Returning to FIG. 3A, it may be seen that expression determination module 286 may receive any combination of verbal communication information 302, non-verbal communication information 304, second user information 306 and second user avatar information 308 and determine expression prediction 318.

Expression prediction 318 is a prediction of what was being expressed by first user 102, captured via verbal communication information 302 and/or non-verbal communication information 304. Expression prediction 318 may be an array with at least two dimensions: one for potential expressions and one for associated weights for various avatar actions or animations. Tables 1 and 2 depict two different examples expression prediction 318 below. In Table 1, expression prediction 318 is represented by a two-dimensional array with actions and weights. In Table 2, expression prediction 318 is represented by a two-dimensional array including three categories: states, emotes, and expressions. Each category has respective activities or emotions, and each activity or emotion has a respective weight.

TABLE 1

| Actions | Weight |
|---|---|
| Sneak_pose | 0.15 |
| Sad_pose | 0.38 |
| Agree | 0.92 |
| Headshake | 0 |

TABLE 2

| Category | Activity/emotion | Weight |
|---|---|---|
| States | Walking | 0.78 |
| States | Sitting | 0.23 |
| States | Running | 0.55 |
| Emotes | Jump | 0.31 |
| Emotes | Yes | 0.71 |
| Emotes | No | 0.25 |
| Emotes | Wave | 0.69 |
| Emotes | Punch | 0.78 |
| Emotes | Thumbs up | 0.85 |
| Expressions | Angry | 0.12 |
| Expressions | Surprised | 0.69 |
| Expressions | Sad | 0.21 |

In examples, expression prediction 318 may include weights or probabilities. In examples, the expression from expression prediction 318 with the highest weight may be selected to animate an avatar. For example, in example expression prediction 318 of Table 1, the “agree” expression has the highest weight, and therefore it may be selected to animate an avatar. In examples, a smoothing algorithm may be applied when selecting an expression to animate an avatar. Temporal smoothing may be applied frame by frame to an avatar animation, for each expression within expression prediction 318. Smoothing may help avoid sudden switching or flickering of states, for example, sad->happy->sad, if a high weight output for just one frame.

Expression determination module 286 may comprise a machine learning model trained (e.g., using supervised or semi-supervised training) on verbal and non-verbal communication information. In examples, expression determination module 286 may be trained using datasets of conversations and social media videos.

In examples where expression determination module 286 receives verbal communication information 302, expression prediction 318 may indicate animating first avatar 110 with non-verbal expression. In examples where expression determination module 286 receives non-verbal communication information 304, expression prediction 318 may indicate animating first avatar 110 with verbal expression. In this way, expression determination module 286 may generate a cross-modal representation of the first user 102 via first avatar 110. Instead of merely mimicking a user, first avatar 110 may therefore provide an enhanced version of the user's verbal and/or non-verbal communication style.

A table of example communication from first user 102 that may correlate with expression prediction 318 for first avatar 110 is provided below in Table 3.

TABLE 3

| User communication | Expression Prediction |
|---|---|
| User says, “Hi, how are you?” | Avatar waves |
| User says, “Eh . . . let me think” | Avatar rubs head |
| User says, “I have a dream that | Avatar stands with hands |
| one day every valley shall be | raised like a preacher |
| exalted, every hill and mountain | |
| shall be made low, the rough | |
| places will be made plain” | |
| User says, “Let's go fishing | Avatar is depicted with a |
| tonight!” | fishing rod |
| User waves | Avatar says, “Hi!” |
| User shrugs | Avatar says, “I don't know” |

In examples, processor 274 may be configured with instructions to execute avatar animation module 288. As may be seen in FIG. 3A, avatar animation module 288 may be operable to receive expression prediction 318 and animate or render first avatar 110 with any combination of non-verbal or verbal expression indicated by expression prediction 318, generating an avatar animation 320. In examples, avatar animation 320 may generate one or more frames, possibly with an associated audio track, depicting first avatar 110 moving, making expressions, and possibly even speaking. In examples, expression prediction 318 may also comprise rendering the avatar into a series of frames and generating an audio file to be played with the frames.

FIG. 3B depicts flowchart 350, according to an example. Flowchart 350 may be used to animate first avatar 110. Flowchart 350 may be similar to flow diagram 300, except that expression determination module 286 comprises encoder 312, embeddings 313, multi-head attention 315, and transformer model 316.

The encoder 312 can be configured to receive verbal communication information 302, non-verbal communication information 304, second user information 306 and/or second user avatar information 308 and encode this information as embeddings 313. Encoder 312 may be configured to generate embeddings 313 including information representing verbal and non-verbal communication of first user 102. Encoder 312 may be further configured to generate embeddings 313 including information representing verbal and non-verbal communication of second user 104 and/or second avatar 112 as well. Embeddings 313 can be used to represent discrete variables as continuous vectors. In other words, an embedding can be a mapping of a discrete (e.g., categorical) variable to a vector of continuous numbers.

Encoder 312 may be configured to categorize verbal communication information 302, non-verbal communication information 304, second user information 306 and/or second user avatar information 308 as discrete variables and map them to vector(s) of continuous numbers (e.g., an embedding). Encoder 312 may be a neural network (e.g., deep-learning, a two-dimensional (2D) convolutional neural network (CNN), LSTM, Transformer, etc.) trained (e.g., pretrained) to generate the embeddings including being trained (e.g., pretrained) to identify the verbal and non-verbal communication, categorize the identified verbal communication information 302, non-verbal communication information 304, second user information 306, and second user avatar information 308, and generate embeddings 313. Training the neural network (of the encoder 312) can include using, for example, social media videos. Thus, the training may include using a supervised learning technique.

Embeddings 313 is a numerical representation of the input that transformer model 316 can use to understand the relationships between different types of information. Embeddings 313 may map all verbal and non-verbal communication such as speech, gesture, and facial expressions into a single latent space of a language model, thus making it possible for the model to generate and respond to different types of expressions in a consistent manner. An embedding is a numerical representation of the input that the network can use to understand the relationships between different types of information.

For example, verbal communication information 302 may include word vectors, for example word vectors created using the word2vec model. The word2vec model receives a text corpus as input and produces the word vectors as output, constructing a vocabulary from the training text data and then learning vector representation of words. In examples the word vector may include the most recent 100 words spoken by a user. In examples, verbal communication information 302 may further include a matrix of spectrum array of the most recent 10 seconds of audio data. In examples, the word vector and matrix of spectrum array may be concatenated together to generate an embedding.

In examples, non-verbal communication information 304 may include facial expressions and/or body poses generated from a frame using, for example, the MediaPipe™ model. MediaPipe may create a tensor of 468x3 (x, y, z) for a facial expression and a tensor of 32x3 (x, y, z) for a body pose.

In examples, second user information 306 may include similar information or embeddings to those described with regards to verbal communication information 302 and non-verbal communication information 304 above.

In an example, second user avatar information 308 may include the embedding of second avatar 112.

Multi-head attention 315 in transformer networks may be a way for the model to focus on different parts of the input sequence at the same time. This may be accomplished by dividing the input into multiple parts, or “heads,” and then looking at each part separately. Multi-head attention 315 may use each head to weigh the importance of different parts of the input and then combine the information from all the heads to make a final decision. Multi-head attention 315 helps transformer model 316 understand the relationships between different parts of the input and make better predictions.

A description of a transformer architecture for transformer network 316 may be found at (Vaswani, A., & Shazeer, N. (2017). Attention is All You Need. https://arxiv.org/pdf/1706.03762.pdf. https://arxiv.org/pdf/1706.03762.pdf. Transformer model 316 is a deep learning model that adopts the mechanism of self-attention, differentially weighting the significance of each part of the input data. Similar to recurrent neural networks (RNNs), transformer model 316 may process sequential input data, such as natural language, and is well-suited to applications such as translation and text summarization. However, unlike RNNs, transformer model 316 may process the entire input all at once. The attention mechanism may provide context for any position in the input sequence. For example, if the input data is a natural language sentence, the transformer may not have to process one word at a time. This allows for more parallelization than RNNs and therefore reduces training times.

Transformer model 316 may work with any combination of verbal communication information 302, non-verbal communication information 304, second user information 306, and second user avatar information 308 as input via embeddings 313. Encoder 312 may combine multiple inputs into embeddings 313 to form a complete understanding of the input. Multi-head attention 315 weighs the importance of each type of information and make predictions based on the combined information. By using multiple sources of information, transformer model 316 may make more accurate predictions and understand the relationships between different types of information.

In examples, first avatar 110 may be given a choice for whether first avatar 110 is animated with expression prediction 318. For example, if second avatar 112 is waving at first avatar 110, a set of potential actions for first avatar 110 may be suggested via an interface to first user 102, for example “wave back”, “say hello” and “ignore” via head mounted device display 240.

In examples, first user 102 may be able to select the expressions for which weights or probabilities are determined via expression determination module 286.

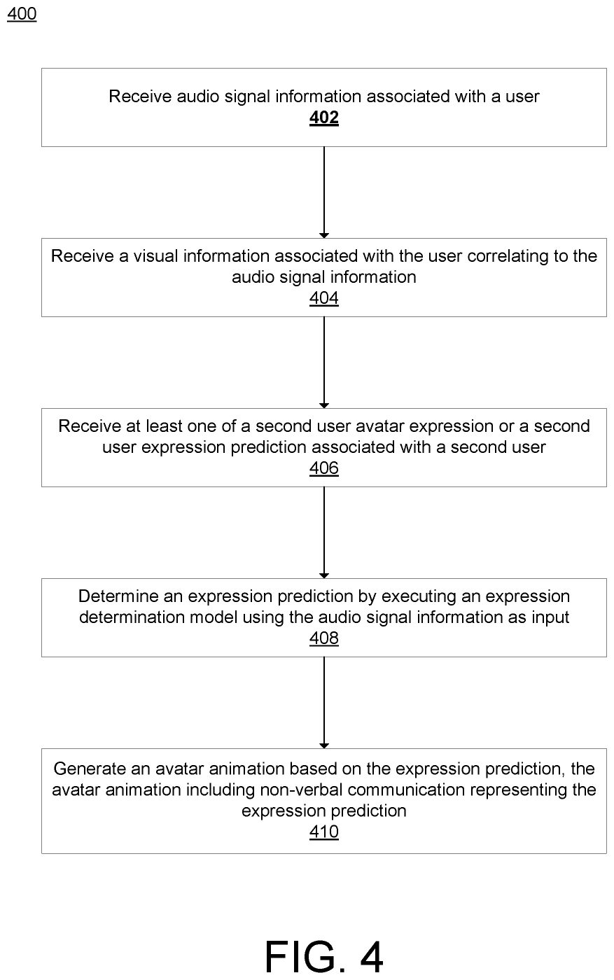

FIG. 4 depicts a flow diagram of method 400, according to an example. Method 400 is a computer-implemented method that may be used to generate expression prediction 318 and avatar animation 320. Instructions and/or executable code to for the performance of method 400 may be stored in memory 276, and the stored instructions may be executed on processor 274.

Method 400 begins with step 402. In step 402, audio signal information, for example verbal communication information 302, associated with first user 102 is received, as described above. For example, verbal information module 280 may be executed in step 402.

Method 400 continues with step 404. In step 404, non-verbal communication information 304 associated with first user 102 is received correlating to the audio signal information, as described above. For example, non-verbal information module 282 may be executed in step 404.

Method 400 continues with step 406. In step 406, at least one of second user information 306 or second user avatar information 308 is received associated with second user 104, as described above. For example, second user information module 284 may be executed in 406.

Method 400 continues with step 408. In step 408, expression prediction 318 is determined by executing expression determination model 286 using the audio signal information as input, as described above.

Method 400 continues with step 410. In step 410, avatar animation 320 generated based on expression prediction 318, avatar animation 320 including non-verbal communication representing expression prediction 318, as described above. For example, avatar animation module 288 may be executed in step 410.

The methods described in this disclosure may generate more engaging multimodal actions for avatars because the avatars do more than simply mimic, they provide enhanced expression over the users that they are associated with. In some examples avatars animated by the methods of this disclosure can also appear to react to and interact with another user's avatar. This may help provide a more engaging interaction with another user, deepening the understanding between users.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, wherein the audio signal information includes at least one of a text interpretation of speech, an audio file, language information, or a speech spectrum.

In some aspects, the techniques described herein relate to a method, wherein the avatar animation is further operable to animate a user avatar with verbal expression.

In some aspects, the techniques described herein relate to a method, further including: receiving non-verbal information associated with the user correlating to the audio signal information; wherein determining the expression prediction further includes executing the expression determination model using the non-verbal information as input.

In some aspects, the techniques described herein relate to a method, wherein the non-verbal information includes at least one of one or more frames, facial expression information, body pose information, or a depth map of a face.

In some aspects, the techniques described herein relate to a method, wherein the expression determination model includes a transformer model.

In some aspects, the techniques described herein relate to a method, wherein the avatar animation includes at least one of a facial expression, a hand gesture, a prop, a body motion, or a speech.

In some aspects, the techniques described herein relate to a method, wherein the user is a first user, and the expression prediction is a first user expression prediction, and the method further includes: receiving at least one of a second user avatar information or a second user information prediction associated with a second user, wherein determining the first user expression prediction further includes executing the expression determination model using the at least one of the second user avatar information or the second user information prediction as input.

In some aspects, the techniques described herein relate to a system, wherein the audio signal information includes at least one of a text interpretation of speech, an audio file, language information, or a speech spectrum.

In some aspects, the techniques described herein relate to a system, wherein the avatar animation is further operable to animate a user avatar with verbal expression.

In some aspects, the techniques described herein relate to a system, further including: a non-verbal information module configured to receive a non-verbal information associated with the user correlating to the audio signal information; wherein the expression determination module is further configured to determine the expression prediction by executing the expression determination model using the non-verbal information as input.

In some aspects, the techniques described herein relate to a system, wherein the non-verbal information includes at least one of one or more frames, facial expression information, body pose information, or a depth map of a face.

In some aspects, the techniques described herein relate to a system, wherein the expression determination model includes a transformer model.

In some aspects, the techniques described herein relate to a system, wherein the avatar animation includes at least one of a facial expression, a hand gesture, a prop, a body motion, or a speech.

In some aspects, the techniques described herein relate to a system, wherein the user is a first user, and the expression prediction is a first user expression prediction, and the system further includes: a second user information module configured to receive at least one of a second user avatar information or a second user information prediction associated with a second user, wherein determining the first user expression prediction further includes executing the expression determination model using the at least one of the second user avatar information or the second user information prediction as input.

In some aspects, the techniques described herein relate to a computing device, wherein the audio signal information includes at least one of a text interpretation of speech, an audio file, language information, or a speech spectrum.

In some aspects, the techniques described herein relate to a computing device, wherein the avatar animation is further operable to animate a user avatar with verbal expression.

In some aspects, the techniques described herein relate to a computing device, wherein the executable instructions include instructions that, when executed by the at least one processor, further cause the computing device to: receive a non-verbal information associated with the user correlating to the audio signal information, wherein determining the expression prediction further includes executing the expression determination model using the non-verbal information as input.

In some aspects, the techniques described herein relate to a computing device, wherein the non-verbal information includes at least one of one or more frames, facial expression information, body pose information, or a depth map of a face.

In some aspects, the techniques described herein relate to a computing device, wherein the expression determination model includes a transformer model.

In some aspects, the techniques described herein relate to a computing device, wherein the avatar animation includes at least one of a facial expression, a hand gesture, a prop, a body motion, or a speech.

In some aspects, the techniques described herein relate to a computing device, wherein the user is a first user, and the expression prediction is a first user expression prediction, and wherein the executable instructions include instructions that, when executed by the at least one processor, further cause the computing device to: receive at least one of a second user avatar information or a second user information prediction associated with a second user, wherein determining the first user expression prediction further includes executing the expression determination model using the at least one of the second user avatar information or the second user information prediction as input.

What is claimed is:

1. A method comprising:
receiving audio signal information associated with a user;
determining an expression prediction by executing an expression determination model using the audio signal information as input; and
generating an avatar animation based on the expression prediction, the avatar animation including non-verbal expression representing the expression prediction.

2. The method of claim 1, wherein the audio signal information comprises at least one of a text interpretation of speech, an audio file, language information, or a speech spectrum.

3. The method of claim 1, wherein the avatar animation is further operable to animate a user avatar with verbal expression.

4. The method of claim 1, further comprising:
receiving non-verbal information associated with the user correlating to the audio signal information;
wherein determining the expression prediction further comprises executing the expression determination model using the non-verbal information as input.

5. The method of claim 4, wherein the non-verbal information comprises at least one of one or more frames, facial expression information, body pose information, or a depth map of a face.

6. The method of claim 1, wherein the expression determination model includes a transformer model.

7. The method of claim 1, wherein the avatar animation comprises at least one of a facial expression, a hand gesture, a prop, a body motion, or a speech.

8. The method of claim 1, wherein the user is a first user, and the expression prediction is a first user expression prediction, and the method further comprises:
receiving at least one of a second user avatar information or a second user information prediction associated with a second user,
wherein determining the first user expression prediction further comprises executing the expression determination model using the at least one of the second user avatar information or the second user information prediction as input.

9. A system comprising:
an audio information module configured to receive audio signal information associated with a user;
an expression determination module configured to determine an expression prediction by executing an expression determination model using the audio signal information as input; and
an avatar animation module configured to generate an avatar animation based on the expression prediction, the avatar animation including non-verbal expression representing the expression prediction.

10. The system of claim 9, wherein the audio signal information comprises at least one of a text interpretation of speech, an audio file, language information, or a speech spectrum.

11. The system of claim 9, wherein the avatar animation is further operable to animate a user avatar with verbal expression.

12. The system of claim 9, further comprising:
a non-verbal information module configured to receive a non-verbal information associated with the user correlating to the audio signal information;
wherein the expression determination module is further configured to determine the expression prediction by executing the expression determination model using the non-verbal information as input.

13. The system of claim 12, wherein the non-verbal information comprises at least one of one or more frames, facial expression information, body pose information, or a depth map of a face.

14. The system of claim 9, wherein the expression determination model includes a transformer model.

15. The system of claim 9, wherein the avatar animation comprises at least one of a facial expression, a hand gesture, a prop, a body motion, or a speech.

16. The system of claim 9, wherein the user is a first user, and the expression prediction is a first user expression prediction, and the system further comprises:
a second user information module configured to receive at least one of a second user avatar information or a second user information prediction associated with a second user,
wherein determining the first user expression prediction further comprises executing the expression determination model using the at least one of the second user avatar information or the second user information prediction as input.

17. A computing device, comprising:
at least one processor; and
a non-transitory computer-readable medium storing executable instructions that, when executed by the at least one processor, cause the computing device to:
receive audio signal information associated with a user;
determine an expression prediction by executing an expression determination model using the audio signal information as input; and
generate an avatar animation based on the expression prediction, the avatar animation including non-verbal expression representing the expression prediction.

18. The computing device of claim 17, wherein the audio signal information comprises at least one of a text interpretation of speech, an audio file, language information, or a speech spectrum.

19. The computing device of claim 17, wherein the avatar animation is further operable to animate a user avatar with verbal expression.

20. The computing device of claim 17, wherein the executable instructions include instructions that, when executed by the at least one processor, further cause the computing device to:
receive a non-verbal information associated with the user correlating to the audio signal information,
wherein determining the expression prediction further comprises executing the expression determination model using the non-verbal information as input.

21. The computing device of claim 20, wherein the non-verbal information comprises at least one of one or more frames, facial expression information, body pose information, or a depth map of a face.

22. The computing device of claim 17, wherein the expression determination model includes a transformer model.

23. The computing device of claim 17, wherein the avatar animation comprises at least one of a facial expression, a hand gesture, a prop, a body motion, or a speech.

24. The computing device of claim 17, wherein the user is a first user, and the expression prediction is a first user expression prediction, and wherein the executable instructions include instructions that, when executed by the at least one processor, further cause the computing device to:
receive at least one of a second user avatar information or a second user information prediction associated with a second user,
wherein determining the first user expression prediction further comprises executing the expression determination model using the at least one of the second user avatar information or the second user information prediction as input.
